(19) United States
(12) Patent Application Publication
(10) Pub. No.: US 2024/0005282 A1
(43) Pub. Date: Jan. 4, 2024

(54) CONVERSATION MANAGEMENT DEVICE, CONVERSATION MANAGEMENT METHOD, AND COMPUTER PROGRAM

(71) Applicant: PERSOL CAREER CO., LTD., Tokyo (JP)

(72) Inventors: Yu KUWAHARA, Tokyo (JP); Yuta MADATE, Tokyo (JP); Taisuku HAYASHI, Tokyo (JP)

(21) Appl. No.: 18/252,830

(22) PCT Filed: Jul. 12, 2021
(86) PCT No.: PCT/JP2021/026183

§ 371 Date: May 12, 2023

(30) Foreign Application Priority Data
Nov. 13, 2020 (JP) 2020-189422

(51) Int. Cl. G06Q 10/1053; G06Q 50/30; G06Q 10/02

(52) U.S. Cl. CPC G06Q 10/1053; G06Q 50/30; G06Q 10/02

(57) ABSTRACT

An object of the present invention is to efficiently use travel time.

The conversation management device 1 includes a reception unit that receives an input regarding a pickup time, a pickup location, and a destination of the taxi for the first user, a reservation unit that stores the dispatch reservation information of the taxi including the pickup time and the pickup location, a conversation time frame calculation unit that calculates a drop-off time based on the pickup location and the destination, and calculates a stay time in the taxi as a conversation-available time based on the pickup time and the drop-off time, a display control unit that causes the second user terminal to display the conversation-available time of the first user, and a conversation setting unit that stores date and time for a conversation between the first user and the second user, and the like.

### TECHNICAL FIELD

The present invention relates to a technology for conducting an in-taxi conversation by utilizing a travel time while traveling by a taxi.

### BACKGROUND ART

Nowadays the travel time required for commuting is enormous, but utilization of the travel time has been limited so far. Therefore, there is a need for a technology capable of producing a disposable time for a busy working person by utilizing the travel time.

Patent Literature 1 describes predicting an arrival time to a destination in advance, downloading video content suitable for the predicted travel time from a video content distribution system to a storage device of a video showing device in a taxi via a mobile phone, and displaying (showing) the video content on a monitor. Patent Literature 2 describes that information is bidirectionally transmitted and received in a vehicle in a conversational system that displays an advertisement and also receives an input from a user in a system arranged in a taxi. Patent Literature 3 describes a method of adjusting an interview schedule by determining an interviewer on the basis of an interview date or the like desired by an interviewee and registering the interviewee in the interviewer's schedule.

### CITATION LIST

### Patent Literature

Patent Literature 1: JP 2004-334628 A
Patent Literature 2: JP 2004-515797 W
Patent Literature 3: JP 2004-280338 A

### SUMMARY OF INVENTION

### Technical Problem

An object of the present invention is to efficiently utilize a travel time.

### Solution to Problem

In order to achieve the above object, a conversation management device according to one aspect of the present invention is configured to be communicable with a vehicle terminal mounted in a taxi and used by a first user in the taxi and a second user terminal used by a second user and enables a conversation by video call between the vehicle terminal and the second user terminal, in which the conversation management device includes: a reception unit that receives an input regarding a pickup time, a pickup location, and a destination of the taxi for the first user; a reservation unit that stores the dispatch reservation information of the taxi including the pickup time and the pickup location; a conversation time frame calculation unit that calculates a drop-off time based on the pickup location and the destination and calculates a stay time in the taxi as a conversation-available time based on the pickup time and the drop-off time; a first user information storage unit that records the conversation-available time in association with identification information of the first user; a display control unit that causes the second user terminal to display the conversation-available time of the first user; a conversation setting unit that stores date and time for a conversation between the first user and the second user; and a video call unit that connects the vehicle terminal and the second user terminal to perform a video conversation at the date and time of the conversation.

The conversation management device may be configured to be further communicable with an interviewer terminal used by an interviewer. The display control unit may cause the interviewer terminal to display the conversation-available time of the first user. The conversation setting unit may store date and time of a proxy conversation that the interviewer has a proxy conversation with the first user by a video call based on an input from the interviewer terminal. The video call unit may connect the interviewer terminal and the vehicle terminal to perform the proxy conversation, and further include a video reproduction unit that causes the second user terminal to reproduce a moving image of the proxy conversation.

The conversation management device may be configured to be communicable with a plurality of second user terminals. The video reproduction unit may cause the plurality of second user terminals to reproduce the moving image of the proxy conversation at the same time.

The video call unit may record the moving image of the proxy conversation. The video reproduction unit may cause the second user terminal to reproduce the recorded proxy conversation.

The conversation management device may further include a question processing unit that receives a question to the first user input via the second user terminal and transmits the question to the interviewer terminal.

The first user may be a job applicant and the second user is a recruiter who considers hiring the job applicant. The first user information storage unit may store information on a resume of the first user in association with the identification information of the first user. The display control unit may cause the second user terminal to display the information on the resume.

In order to achieve the above object, a conversation management method according to another aspect of the present invention is a method by a computer that is configured to be communicable with a vehicle terminal mounted in a taxi and used by a first user in the taxi and a second user terminal used by a second user, the computer enables a conversation by a video call between the vehicle terminal and the second user terminal, and the conversation management method includes: a reception process of receiving an input a pickup time, a pickup location, and a destination of the taxi for the first user; a reservation process of storing the dispatch reservation information of the taxi including the pickup time and the pickup location; a drop-off time calculation process of calculating a drop-off time based on the pickup location and the destination; a recording process of calculating a stay time in the taxi as a conversation-available time based on the pickup time and the drop-off time and recording the conversation-available time in association with identification information of the first user; a display process of causing the second user terminal to display the conversation-available time of the first user; a conversation setting process of storing date and time of a conversation between the first user and the second user; and a video call process of connecting the vehicle terminal and the second user terminal to perform a video conversation at the date and time of the conversation.

In order to achieve the above object, a computer program according to another aspect of the present invention is a computer program for a computer that is configured to be communicable with a vehicle terminal mounted in a taxi and used by a first user in the taxi and a second user terminal used by a second user, the computer enables a conversation by a video call between the vehicle terminal and the second user terminal, and the computer program causes the computer to perform processes including: a reception process of receiving an input regarding a pickup time, a pickup location, and a destination of the taxi for the first user; a reservation process of storing the dispatch reservation information of the taxi including the pickup time and the pickup location; a drop-off time calculation process of calculating a drop-off time based on the pickup location and the destination; a recording process of calculating a stay time by the taxi as a conversation-available time based on the pickup time and the drop-off time and recording the conversation-available time in association with identification information of the first user; a display process of causing the second user terminal to display the conversation-available time of the first user; a conversation setting process of storing date and time of a conversation between the first user and the second user; and a video call process of connecting the vehicle terminal and the second user terminal to perform a video conversation at the date and time of the conversation.

Note that the computer program can be provided by being stored in various data readable recording media, or can be provided in a downloadable manner via a network such as the Internet.

### Advantageous Effects of Invention

According to the present invention, the travel time can be efficiently used.

### BRIEF DESCRIPTION OF DRAWINGS

FIG. 1 is a schematic diagram that illustrates an outline of an interview management system according to an embodiment of the present invention.

FIG. 2 is a functional block diagram that illustrates a configuration and a function of the interview management system according to the embodiment of the present invention.

FIG. 3 is a diagram that illustrates an example of a data table stored in the interview management system according to the embodiment of the present invention, in which (a) illustrates an example of data stored in a job applicant information storage unit, and (b) illustrates an example of data stored in a dispatch information storage unit.

FIG. 4 illustrates an example of a screen displayed on a recruiter terminal in the interview management system according to the embodiment of the present invention.

FIG. 5 is a sequence diagram that illustrates an example of a processing flow for determining a profile of a job applicant and a dispatch reservation among processing executed in the interview management system according to the embodiment of the present invention.

FIG. 6 is a sequence diagram that illustrates an example of a processing flow in which a proxy conversation by video call is performed between a vehicle terminal and an interviewer terminal and a question is received from the interviewer terminal according to need among the processing executed in the interview management system according to the embodiment of the present invention.

FIG. 7 is a sequence diagram that illustrates an example of a processing flow in which an interview is performed by a video call between the vehicle terminal and the recruiter terminal among the processing executed in the interview management system according to the embodiment of the present invention.

### DESCRIPTION OF EMBODIMENTS

### Overview

Hereinafter, an interview management system according to an embodiment of the present invention will be described with reference to the drawings. In the following description, an interview is an example of a conversation, and an interview management device is an example of a conversation management device.

The interview management system according to the present embodiment allocates a taxi in accordance with registration from a job applicant, and conducts a recruitment interview by video call during a stay time in the taxi, thereby efficiently matching recruiters and job applicants. In particular, the job applicant is assumed to regularly reserve a taxi in the present system and use it for commuting.

Here, the taxi refers to a moving body that transports passengers, and is, for example, an automobile, but may be a different object. In addition, a driver may drive the taxi, or the taxi may be self-driving.

Note that the technical scope of the present invention is not limited to the use form assuming human resources recruitment described in the present embodiment, and can be applied to any service in which the travel time is converted into a private disposable time in a taxi by dispatch of a taxi and a video call is performed during the staying time in the taxi. For example, it may be configured such that a person in a taxi receives business of insurance, housing, real estate, or the like through a video call. Furthermore, the present invention is not limited to sales, and a configuration may be employed in which services such as consultation, counseling, and legal consultation are provided by video call. Furthermore, the service may be provided by a person in a taxi using a video call. For example, a sales representative, a consultant, a counselor, a professional person, or the like may ride in a taxi, and the service may be remotely provided to a person using a video call in a taxi. Note that a person who provides a service and a person who is provided with a service may get on different taxies and make a video call during a stay time in each taxi.

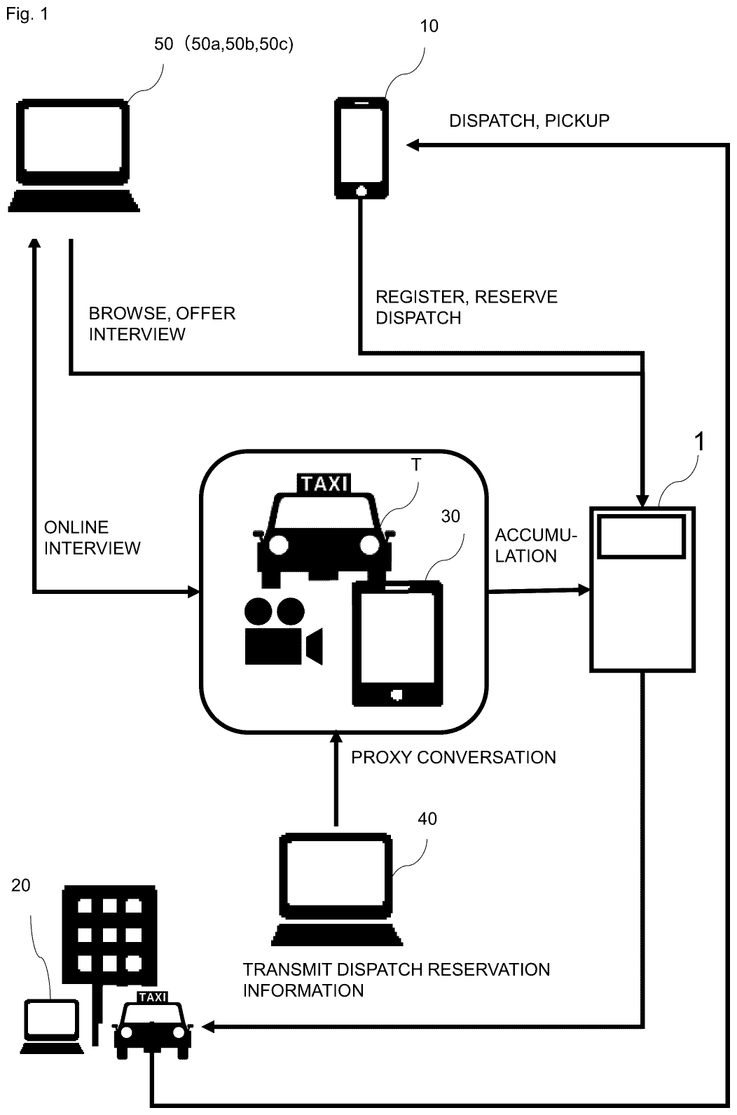

First, an outline of the interview management system according to the present embodiment will be described with reference to FIG. 1.

As illustrated in FIG. 1, the interview management system is assumed to be used by three parties of a job applicant, a recruiter, and an interviewer. In addition, the interview management system can receive information from a terminal of a taxi company that dispatches a taxi to a job applicant, that is, a dispatch terminal 20.

The job applicant is a person who desires a wide range of employment opportunities including a side job, a part-time job, an internship, a full-time employee job, and the like. The job applicant is an example of a first user.

The recruiter is a person who recruits and employs a job applicant. The recruiter is an example of a second user.

The interviewer is a person who performs a proxy conversation for reference when the recruiter considers whether to offer an interview to the job applicant, and is, for example, a person who mediates the recruitment performs this role. The recruiter can watch the proxy conversation in real time or view a recorded interview later. In addition, the interviewer may hold an interview inside or outside the taxi separately from the proxy conversation that the recruiter is allowed to view, collect profile information for creating a personal history or a work history of the job applicant, or provide consultation regarding job seeking as a carrier consultant. In addition, separately from the interviewer, a carrier consultant may communicate with a job applicant terminal using a separate terminal, or may hold an interview via the vehicle.

Each of the job applicant, the recruiter, and the interviewer uses a job applicant terminal 10, a recruiter terminal 50, and an interviewer terminal 40, thereby exchanging data with the interview management device 1. In addition, the job applicant exchanges, in the taxi T, data with the interview management device 1 through a vehicle terminal 30 provided in a taxi T. Note that, although the configuration of each terminal will be described later, the terminals are realized by, for example, smart devices, personal computers, or the like capable of data communication. The recruiter terminal 50 is an example of a second user terminal.

The job applicant performs inputting personal information and a dispatch reservation of the taxi T via the job applicant terminal 10, for example, his/her own smartphone. The information included in the dispatch reservation includes information such as desired date and time of the ride of the taxi T, a pickup location, and a destination. In this system, it is assumed that the job applicant regularly uses the taxi T, and the desired pickup date and time is, for example, information such as “every Friday at 8:00”.

Upon receiving the dispatch reservation, the interview management device 1 transmits the dispatch reservation information to the dispatch terminal 20. The dispatch terminal 20 dispatches the taxi T with reference to its own database or the like, and causes the taxi T to pick up and drop off the job applicant.

The interview management device 1 calculates an interview-available time that can be used for an interview by a job applicant in the taxi T on the basis of a dispatch reservation, and causes the interviewer and the recruiter to browse information on the interview-available time via the interviewer terminal 40 and the recruiter terminal 50. When the interviewer makes a reservation of the proxy conversation date and time via the interviewer terminal 40, the reservation information is recorded in the interview management device 1. In addition, when the recruiter makes a reservation with date and time for an interview via the recruiter terminal 50, the reservation information is recorded in the interview management device 1.

At the reservation time of the proxy conversation, the job applicant has the proxy conversation with the interviewer by video call via the vehicle terminal 30 in the taxi T. In addition, at a reservation time of the interview with the recruiter, the job applicant has the interview by video call via the vehicle terminal 30.

Function Block

Next, functions of the interview management system according to the present embodiment will be described in detail.

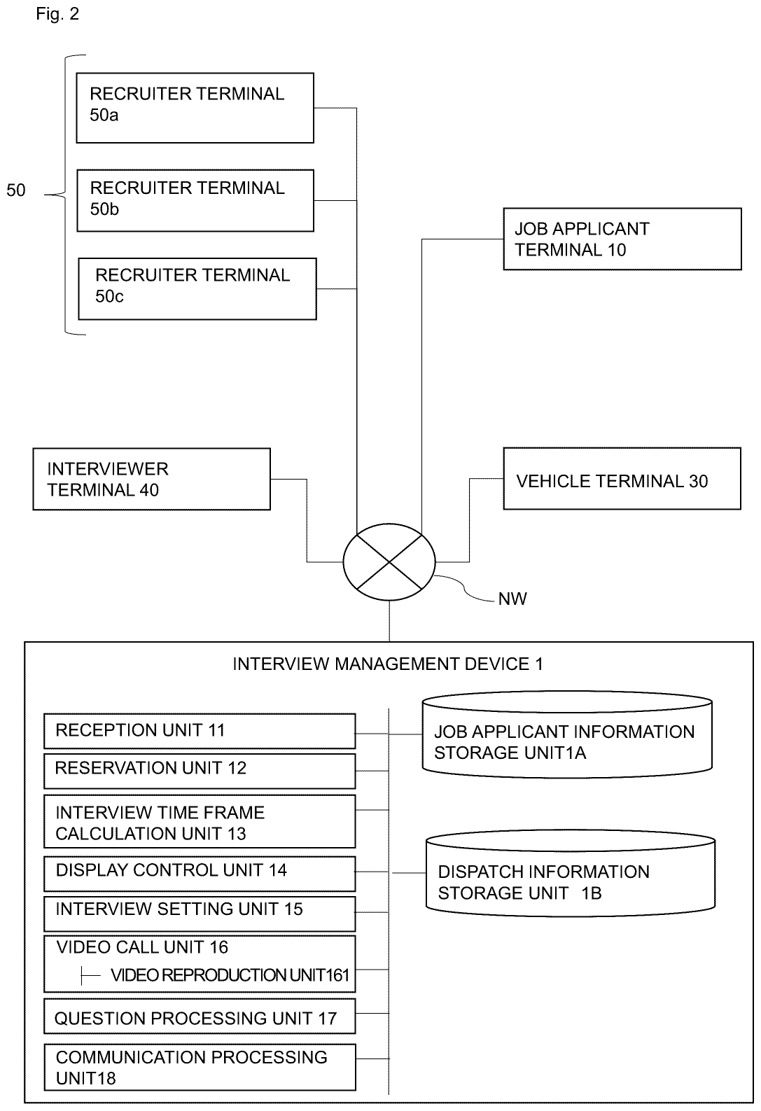

As illustrated in FIG. 2, the interview management system includes the interview management device 1, the job applicant terminal 10, the vehicle terminal 30, the interviewer terminal 40, and the recruiter terminal 50 configured to be able to communicate via a network NW such as the Internet. A plurality of the recruiter terminals 50 may be connected, and according the present embodiment, three recruiter terminals 50a, 50b, and 50c are connected. In this case, the recruiter terminals 50a, 50b, and 50c are assumed to be terminals used by recruiters of different companies.

The job applicant terminal 10 is a terminal used by the job applicant.

The job applicant terminal 10 is realized by, for example, a portable terminal such as a mobile terminal or a tablet terminal capable of transmitting and receiving data.

The job applicant terminal 10 includes at least a communication processing means such as a browser program for executing transmission and reception of data with the interview management device 1, and an input/output means such as a touch display for inputting and outputting data. With the job applicant terminal 10, a profile of the job applicant, a resume sent from the carrier consultant, for example, a draft of a personal history or a work history, and a dispatch schedule, for example, can be browsed via a dedicated application. In addition, the profile, resume, dispatch schedule, and the like can be added, deleted, or modified. Note that the job applicant terminal 10 may be configured to perform the above-described processing via a general-purpose web browser in addition to or instead of the dedicated application.

The vehicle terminal 30 is a terminal mounted on the taxi T.

The vehicle terminal 30 may be a terminal built in the taxi T capable of transmitting and receiving data, or may be used by attaching a mobile terminal or a portable terminal such as a tablet terminal in the vehicle.

The vehicle terminal 30 includes at least a communication processing means for executing transmission and reception of data with the interview management device 1 via the network NW such as the Internet, and a sound collection means, a sound emission means, and a display means for making a video call.

The interviewer terminal 40 is a terminal used by the interviewer who performs a proxy conversation, and is realized by a so-called personal computer, a tablet terminal, a mobile terminal capable of transmitting and receiving data, a so-called smart device, or the like.

The interviewer terminal 40 includes at least an input/output means for inputting and outputting various types of data, a communication processing means for executing transmission and reception of data with the interview management device 1 via the network NW such as the Internet, and a sound collection means, a sound emission means, and a display means for making a video call.

Note that, in the following description, the functions of the terminal used by the carrier consultant is similar to that of the interviewer terminal 40.

The recruiter terminal 50 is a terminal used by the recruiter who recruits a job applicant, and is realized by a so-called personal computer, a tablet terminal, a mobile terminal capable of transmitting and receiving data, a so-called smart device, or the like.

The recruiter terminal 50 includes at least an input/output means for inputting and outputting various types of data, a communication processing means for executing transmission and reception of data with the interview management device 1 via the network NW such as the Internet, and a sound collection means, a sound emission means, and a display means for making a video call.

Note that the recruiter terminal 50 may be a terminal placed in a taxi different from the taxi in which the job applicant rides. When the recruiter performs a login process on the terminal, the terminal functions as the recruiter terminal. Similarly to the job applicant, the recruiter may set a dispatch reservation in advance and takes the taxi. In this case, the vehicle terminal placed on the taxi to be dispatched may be configured to automatically log in to the account of the recruiter associated with the dispatch reservation.

With the recruiter terminal 50, the resume and the dispatch schedule of the job applicant can be browsed via a dedicated application, a general-purpose web browser, or the like. In addition, in the dispatch reservation information, the date and time when the live video of the proxy conversation is distributed by the job applicant can be viewed. When the proxy conversation to be browsed on the recruiter terminal 50 is selected, the browsing schedule is displayed on a calendar displayed on the recruiter terminal 50. In addition, when a date and time for an interview with the job applicant is selected on the recruiter terminal 50, an interview schedule is displayed on the calendar. In either or both of the proxy conversation and the interview, a video conference link is displayed on the recruiter terminal 50, for example, on a calendar, and the recruiter can select the link to view the proxy conversation or initiate a video call for the interview.

The interview management device 1 is a device that mediates exchange of information between the job applicant and the recruiter.

The interview management device 1 is realized by, for example, a server or the like including an arithmetic device such as a central processing unit (CPU), a computer program executed by the CPU, an internal memory such as a random access memory (RAM) or a read only memory (ROM), and the like. With this configuration, as illustrated in FIG. 2, the interview management device 1 forms a functional block including a reception unit 11, a reservation unit 12, an interview time frame calculation unit 13, a display control unit 14, an interview setting unit 15, a video call unit 16, a question processing unit 17, a communication processing unit 18, a job applicant information storage unit 1A, and a dispatch information storage unit 1B.

The reception unit 11 is a functional unit that receives reservation information of a taxi transmitted from the job applicant terminal 10. The reservation information of a taxi includes, for example, a pickup time, a pickup location, and a destination of the taxi. The pickup time is input such as “every Monday at 8:00” on the assumption that the job applicant regularly uses the taxi a plurality of times. Note that the reception unit 11 may further receive the desired drop-off time. In addition, the reception unit 11 receives profile information such as a name and contact information, an educational background, and a work history of the job applicant. The profile information is information including items described in the personal history. In a case where the profile information of the job applicant is not received, the reception unit 11 may be configured not to receive taxi reservation information or not to perform reservation processing. Furthermore, the reception unit 11 may receive the profile information of the job applicant from the interviewer terminal 40 or the carrier consultant terminal. According to the configuration in which the interviewer or the carrier consultant can input the information obtained from the interview as the profile information of the job applicant, the personal history or the work history can be created by the interviewer or the carrier consultant, and the job seeking activity becomes convenient for the job applicant.

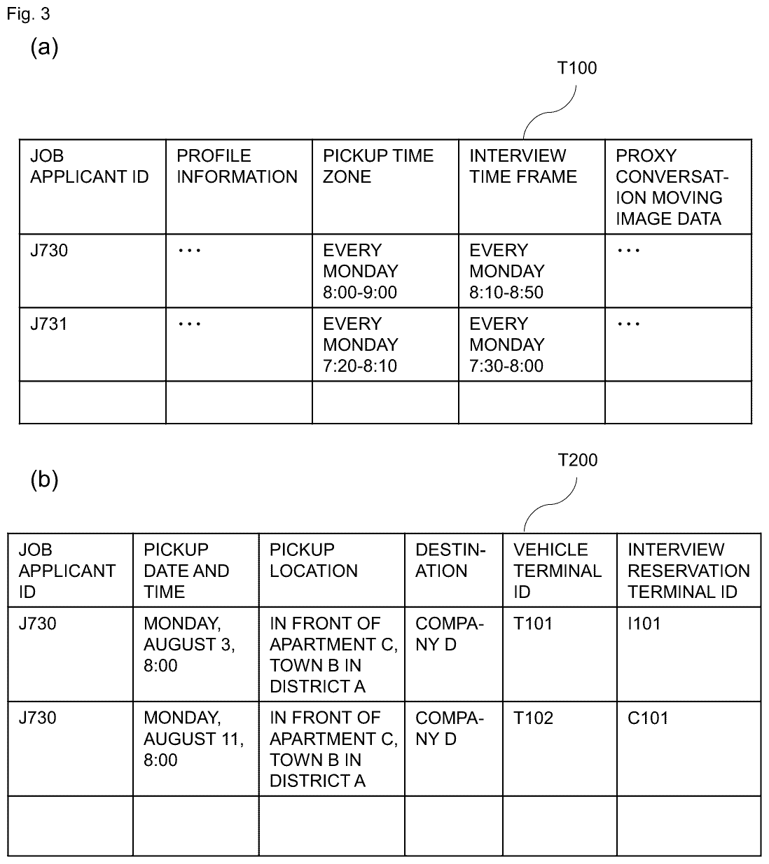

The reservation unit 12 is a functional unit that stores taxi dispatch reservation information including the pickup time and the pickup location in a job applicant information table T100 (see FIG. 3(a)) stored in the job applicant information storage unit 1A.

The job applicant information table T100 stores profile information of the job applicant, a pickup time zone in which the job applicant gets on the taxi, and the like. In addition, a time zone in which an interview can be performed in the taxi is stored. Furthermore, in a case where a moving image of a proxy conversation to be described later is recorded, moving image data of the proxy conversation is stored in association with identification information of the job applicant.

The interview time frame calculation unit 13 is a functional unit that calculates a stay time in the taxi as the interview-available time. This is because the inside of the taxi is a private space without the possibility of being heard by others except for the driver, and the time in the taxi can be utilized for the video call with the interviewer or the recruiter.

The interview time frame calculation unit 13 calculates the drop-off time on the basis of the pickup location and the destination. At this time, the interview time frame calculation unit 13 refers to, for example, map data on the Internet, acquires a time required for the travel, and calculates the drop-off time. Furthermore, the interview time frame calculation unit 13 may predict the traffic jam status of the travel route on the basis of the pickup time and calculate the drop-off time in consideration of the traffic jam status.

The calculated drop-off time is stored in the job applicant information table T100.

The interview time frame calculation unit 13 calculates a time frame in which an interview can be performed, that is, a start possible time and an end time on the basis of the pickup time and the calculated drop-off time. The interview time frame is a time included between the pickup time and the drop-off time, and the time from the pickup time to the drop-off time may be set as the time frame of the interview. Furthermore, the interview time frame calculation unit 13 may set, for example, a time from a predetermined time after pickup to a predetermined time before drop-off time as the interview time frame. According to this configuration, since the interview is set to be shorter than the stay time in the taxi in advance, even if the pickup time and the drop-off time deviate from the schedule due to traffic conditions or the like, the scheduled time for the interview can be secured.

The calculated interview time frame is stored in the job applicant information table T100.

Note that the interview time frame calculation unit 13 may recalculate the schedule of the drop-off time as needed during the interview, and display the schedule, via the display control unit 14, on the vehicle terminal 30 and the terminal making the video call, that is, the interviewer terminal 40 or the recruiter terminal 50. This is because the drop-off time changes due to traffic conditions. In addition, the remaining time of the interview time may be calculated and displayed on the vehicle terminal 30 or the terminal making the video call, or the fact that the remaining time has reached a predetermined time may be displayed on the vehicle terminal 30 or the terminal making the video call.

The display control unit 14 is a functional unit that causes the interviewer terminal 40 and the recruiter terminal 50 to display the interview time frame of the job applicant. The interviewer terminal 40 and the recruiter terminal 50 can also display the profile information of the job applicant stored in the information of the job applicant information table T100. According to this configuration, in particular, since the information included in the personal history of the job applicant can be browsed by the recruiter, an interview with a desired personnel can be realized, and the recruitment activity can be efficiently performed. In addition, this interview time frame is a disposable time created by dispatch of the taxi T for the job applicant, and is a time assumed to be allocated to a job search activity. In the conventional recruitment activities, an interview is often not held due to the circumstances of the current job of the job applicant, but according to the interview management device according to the present invention, there is a very low possibility that the interview is canceled. In other words, the recruiter can almost certainly conduct an interview with the desired person.

The dispatch information storage unit 1B is a storage unit that stores information regarding regularly-scheduled dispatch of a taxi for the job applicant.

As illustrated in FIG. 3(b), the dispatch information storage unit 1B stores a dispatch information table T200. The dispatch information table T200 stores identification information of the vehicle terminal 30 mounted on the taxi T to be dispatched for a plurality of pickup schedules. According to this configuration, since which vehicle terminal 30 is used by the job applicant in the taxi is stored, it is possible to reliably connect the recruiter terminal 50 or the interviewer terminal 40 to the vehicle terminal 30 of the taxi T on which the job applicant who has reserved the interview or the proxy conversation rides without performing a special operation.

Note that, instead of the above-described configuration, a configuration may be employed in which the vehicle terminal 30 and the job applicant are associated with each other by authentication by the job applicant terminal 10 or input of a password or the like known by the job applicant after the job applicant gets in the taxi T. The same applies to a case where the recruiter uses a terminal in the taxi T as the recruiter terminal.

The interview setting unit 15 is a functional unit that determines the date and time of an interview with the job applicant. When the interviewer terminal 40 inputs the job applicant who takes the proxy conversation and the date and time of the interview, the interview setting unit 15 determines the proxy conversation with the interviewer on the date and time, and records the determined date and time in the dispatch information storage unit 1B. In the example of FIG. 3(b), the pickup date and time and an interview reservation terminal ID are stored in association with each other in the dispatch information table T200. Here, the interview reservation terminal refers to the interviewer terminal 40 and the recruiter terminal 50, and the interview reservation terminal ID is identification information of the interviewer terminal 40 and the recruiter terminal 50.

In addition, when the recruiter terminal 50 inputs the job applicant who takes the interview and the date and time of the interview, the interview setting unit 15 records the date and time of the interview in the dispatch information storage unit 1B. In this example, a proxy conversation with the interviewer terminal 40 whose ID is I101 is scheduled on boarding on August 3rd, and an interview with the recruiter terminal 50 whose ID is C101 is scheduled on boarding on August 11th.

According to the present embodiment, the interviewer terminal 40 or the recruiter terminal 50 is configured to designate and determine the interview date and time from among the interview-available times, but the job applicant terminal 10 may be configured to designate the interview date and time. The configuration in which a first user refers to a schedule of a second user and designates an interview date and time is useful in a case where the second user is a service provider.

The video call unit 16 is a functional unit that connects the vehicle terminal 30 and the recruiter terminal 50 to perform video calls at the interview date and time, and transmits the voice and the moving image collected by the vehicle terminal 30 to the recruiter terminal 50 and transmits the voice and the moving image collected by the recruiter terminal 50 to the vehicle terminal 30. According to this configuration, the job applicant can efficiently search for a job using the travel time required for commuting without visiting to the company of the recruiter.

Note that the interview management device 1 may detect the location of the taxi T by a location detection means such as a GNSS and calculate the estimated time of arrival. The location detection means is, for example, a function mounted on the vehicle terminal 30. In addition, it may be configured such that the taxi T has a location detection means, and the interview management device 1 receives the location information detected by the taxi T.

In addition, at the proxy conversation date and time, the video call unit 16 connects the vehicle terminal 30 and the interviewer terminal 40 to make a video call in a similar manner.

The video call unit 16 includes a video reproduction unit 161 that causes the recruiter terminal 50 to reproduce the moving image of the proxy conversation. The video reproduction unit 161 allows the recruiter terminal 50 to share and play back the video in real time to browse a so-called live video of the proxy conversation. According to this configuration, a general question that can be interviewed through an interviewer can be shared with a plurality of recruiters through one proxy conversation, and both the recruiter and the job applicant can simplify the interviewing. Note that the moving image of the proxy conversation includes, for example, at least a voice and a moving image collected by the vehicle terminal 30 and a voice collected by the interviewer terminal 40, but may include an image of the interviewer captured by the interviewer terminal 40.

The video reproduction unit 161 can simultaneously reproduce the live video of the proxy conversation on the plurality of recruiter terminals 50a to 50c. According to this configuration, since a plurality of recruiters who are interested in the job applicant do not have to meet, a moving image of the job applicant can be easily viewed, and information of the job applicant can be easily obtained without being known to other companies.

Note that the video reproduction unit 161 may be able to designate, for each proxy conversation, whether or not to enable the proxy conversation to be played on the recruiter terminal 50. For example, in a case where the proxy conversation is an interview for hearing a profile of a job applicant, such as a job history and skills, and creating a personal history and a work history on behalf of the job applicant, the proxy conversation does not need to be disclosed, and sometimes includes private information and confidential information regarding the current job. According to the configuration in which the proxy conversation can be selected to be undisclosed to the recruiter terminal 50, such a highly confidential interview is also possible. Note that the proxy conversation in this case may be performed by a carrier consultant different from the interviewer.

Furthermore, the video reproduction unit 161 may record a proxy conversation and store moving image data. The moving image data is stored in the job applicant information storage unit 1A. The video reproduction unit 161 causes the recruiter terminal 50 to reproduce the recorded moving image of the proxy conversation. According to this configuration, even a recruiter who has not been able to view the proxy conversation in real time can know the state of the proxy conversation, so that a matching opportunity can be secured.

The question processing unit 17 is a functional unit that receives a question to the job applicant input from the recruiter terminal 50 and transmits the question to the interviewer terminal 40. The interviewer terminal 40 reports this question by voice or text, and the interviewer shares the question with the job applicant during the proxy conversation. According to this configuration, the recruiter can view the proxy conversation remotely without being known the existence, and at the same time, can also ask an individual question.

Note that the question processing unit 17 may receive a question from the recruiter terminal 50 at a different time from the time of the proxy conversation in addition to the middle of the proxy conversation. If the request is received before the proxy conversation, the request may be transmitted to the interviewer terminal 40 in advance. In this case, the interviewer may ask the job applicant the question during the proxy conversation. In addition, in a case where the question is received after the proxy conversation, the question may be separately displayed on the vehicle terminal 30 while the job applicant is on the taxi T to prompt an answer.

The communication processing unit 18 transmits and receives various data to and from the job applicant terminal the vehicle terminal 30, the interviewer terminal 40, and the recruiter terminals 50a to 50c via the network NW such as the Internet.

Specifically, profile information and dispatch reservation information of the job applicant are received from the job applicant terminal 10. Further, the voice and moving image are transmitted to and received from the vehicle terminal 30, the interviewer terminal 40, and the recruiter terminal 50. Further, the proxy conversation reservation with the job applicant is received from the interviewer terminal 40. From the recruiter terminals 50a to 50c, an interview reservation with the job applicant is received, and a question to the job applicant also is received.

Note that data and notifications can be exchanged with the job applicant, the recruiter, and the interviewer via the job applicant terminal 10, the vehicle terminal 30, the interviewer terminal 40, and the recruiter terminals 50a to 50c in various modes such as via My Page or the like of each of the job applicant, the recruiter, and the interviewer provided on a predetermined website, via a dedicated application, or via e-mail of the job applicant, the recruiter, and the interviewer.

### Screen Example

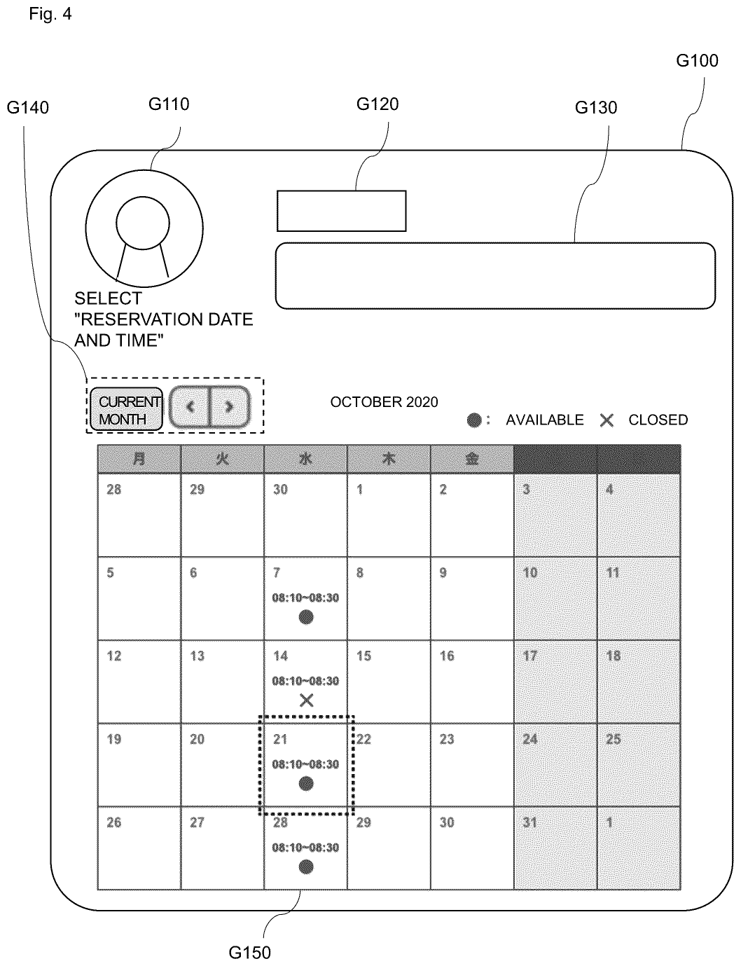

FIG. 4 is an example of a screen G100 displayed on the recruiter terminal 50. When the login processing to the system is performed from the recruiter terminal 50, the profile information of the job applicant is displayed together with the interview-available time in the taxi T. The job applicant displayed on the screen G100 may be extracted according to conditions or the like input from the recruiter terminal 50. In addition, this condition may be an employment condition such as a job history of the job applicant, or may be an extraction method of displaying a job applicant who can have an interview at a certain time.

The screen G100 displays, for example, a face image field G110 of the job applicant, a job applicant name field G120, a profile field G130 in which job histories of the job applicant and the like are summarized, a month designation field G140 for designating a month in which an interview-available time is displayed, an interview-available schedule field G150 in a taxi T, and the like. In the interview-available schedule field G150, a circle or cross mark is displayed in a time zone in which dispatch of a taxi T is scheduled, and no mark is displayed in a time zone in which dispatch is not scheduled. In addition, an interview-available time zone is displayed in the column of a day on which an interview can be reserved, and a cross is displayed in a time zone in which acceptance of an interview is closed. For example, by selecting a field of a day on which an interview can be reserved by tapping, clicking, or the like, the interview can be reserved from the recruiter terminal 50. Note that the screen G100 may also be browsable from the interviewer terminal 40.

Processing Flow

### [Processing Flow Regarding Taxi Dispatch]

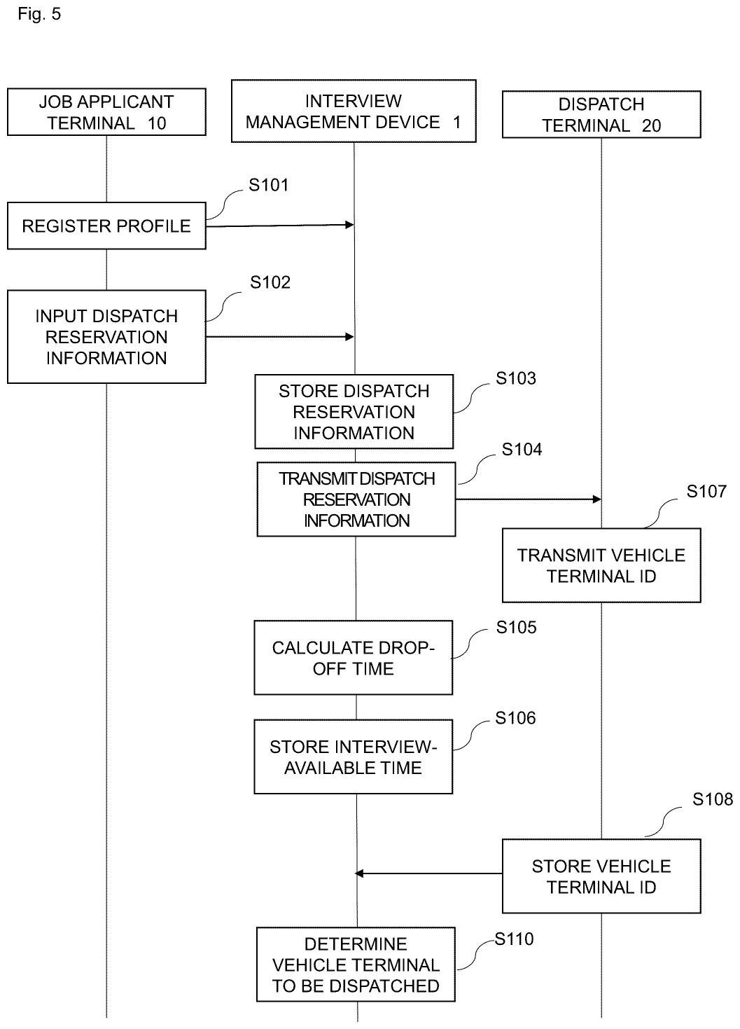

FIG. 5 is a sequence diagram that illustrates an example of a processing flow in which a taxi is dispatched on the basis of a reservation from the job applicant terminal 10.

First, when the job applicant terminal 10 accepts the input of the profile, the interview management device 1 acquires the profile (S101). The interview management device 1 may perform selection processing of a carrier consultant on the basis of the information of the profile. In addition, when the job applicant terminal 10 receives an input of dispatch reservation information and the interview management device 1 acquires the input (S102), the dispatch reservation information is stored in the interview management device 1 (S103). The interview management device 1 transmits the dispatch reservation information to the dispatch terminal 20 (S104). Next, the dispatch terminal 20 determines a vehicle terminal to be dispatched (S107), and transmits identification information of the vehicle terminal 30 to the interview management device 1 (S108). The interview management device 1 receives the identification information of the vehicle terminal 30 and stores the identification information (S110).

In addition, the interview management device 1 calculates a drop-off time according to the dispatch reservation information (S105), and stores an interview-available time of the job applicant in the taxi T (S106).

### [Processing Flow for Proxy Conversation]

Next, a processing flow in which a state of a video call, that is, a proxy conversation performed between the interviewer terminal 40 and the vehicle terminal 30 is browsed from the recruiter terminal 50 and a question is received from the recruiter terminal 50 will be described.

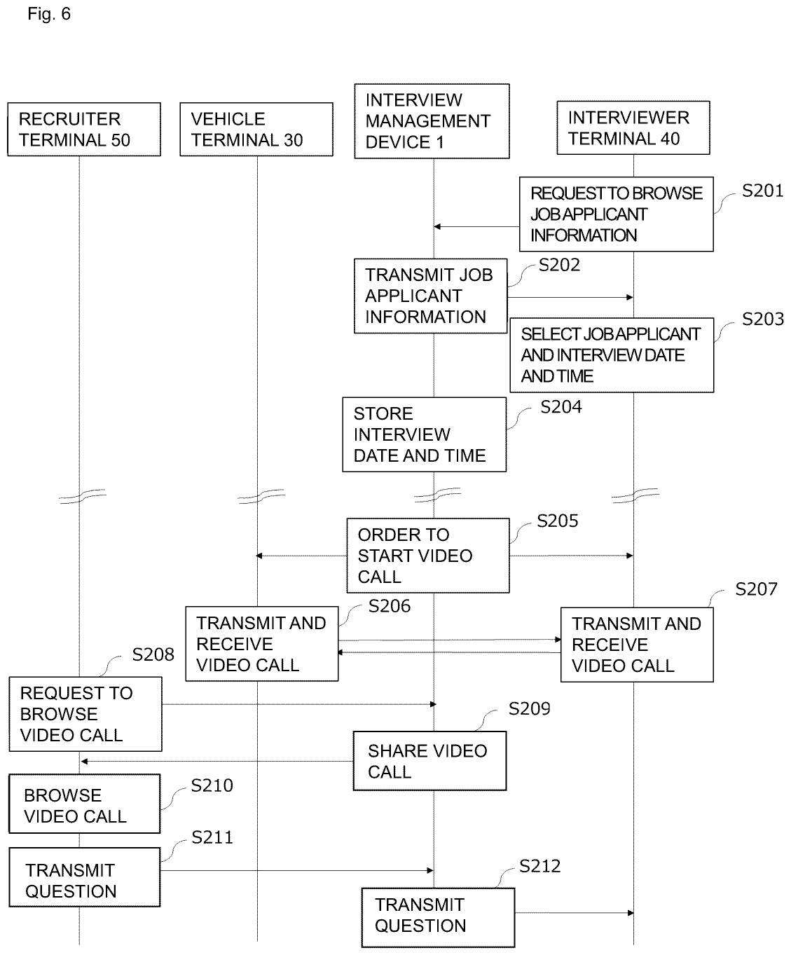

FIG. 6 is a sequence diagram that illustrates a processing flow in which a proxy conversation by a video call is performed between the vehicle terminal 30 and the interviewer terminal 40.

First, a request for viewing the job applicant information is transmitted from the interviewer terminal 40 to the interview management device 1 (S201). The interview management device 1 transmits the job applicant information to the interviewer terminal 40 in response to the browsing request (S202). The interviewer terminal 40 displays the screen G100 on the display unit, and receives the selection of the job applicant of an interview and the date and time of the interview (S203). When the job applicant and the interview date and time are selected, the interview management device 1 stores the interview date and time in the dispatch information table T200 of the job applicant (S204).

The interview management device 1 notifies the job applicant terminal 10 of a reminder a predetermined time before the pickup reservation date and time for the taxi T. Note that, in a case where a proxy conversation is scheduled, the interview management device 1 may give a reminder notification to the job applicant terminal 10 of the job applicant in a mode different from a case where no proxy conversation is scheduled.

At the interview start time, the interview management device 1 refers to the dispatch information table T200 and transmits a video call start command to the vehicle terminal and the interviewer terminal 40 associated with the job applicant ID (S205). Next, transmission and reception of a video call is started between the vehicle terminal 30 and the interviewer terminal 40 (S206, S207).

When the video call browse request is transmitted from the recruiter terminal 50 (S208), the interview management device 1 shares the video call of the proxy conversation with the recruiter terminal 50 (S209), and the voice and the image of the proxy conversation can be browsed on the display unit of the recruiter terminal 50 (S210). Note that the request for browsing the proxy conversation by the recruiter terminal 50 can be transmitted even during the video call for the proxy conversation, or even before the date and time of the proxy conversation. Further, when a question is transmitted from the recruiter terminal 50 during or before browsing (S211), the question is transmitted to the interviewer terminal 40 via the interview management device 1 (S212). In the interviewer terminal 40, this question is displayed on the screen or the like. The interviewer throws this question to the job applicant at an appropriate time during the proxy conversation.

Note that, in the example of the drawing, one recruiter terminal 50 is illustrated, but a plurality of recruiter terminals may be configured to be able to view the proxy conversation at the same time.

[Processing Flow Regarding Interview with Recruiter]

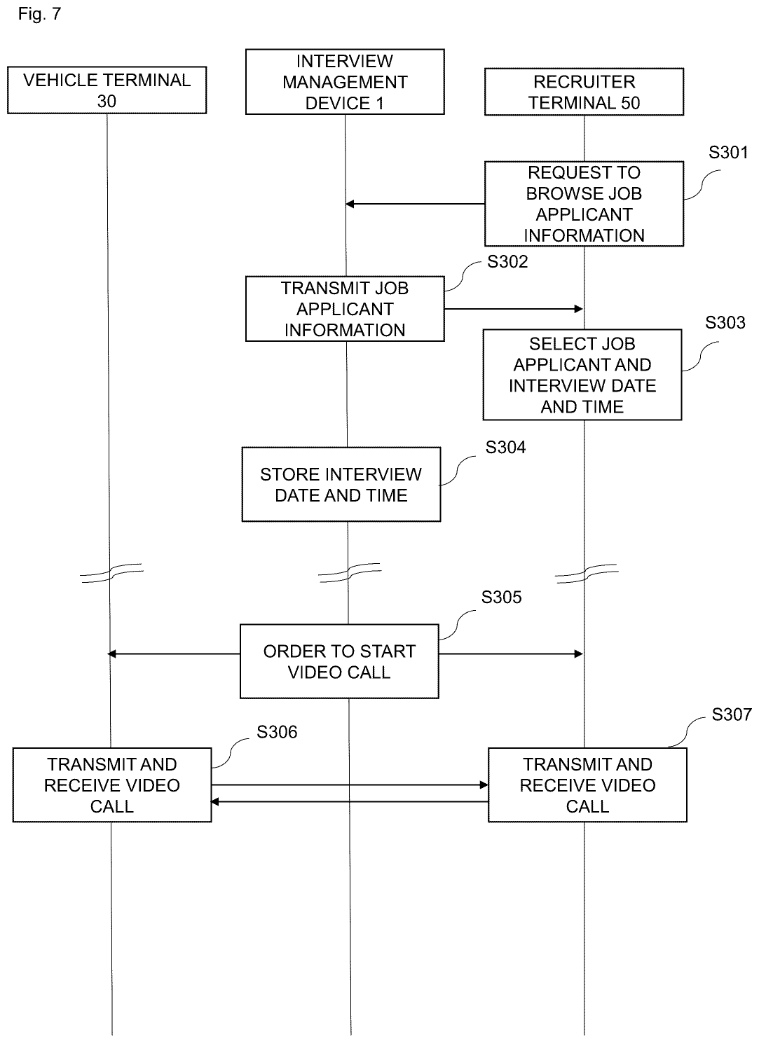

FIG. 7 is a sequence diagram that illustrates a processing flow in which an interview by a video call is performed between the vehicle terminal 30 and the recruiter terminal 50 at the interview-available time in the taxi T.

First, a request for viewing the job applicant information is transmitted from the recruiter terminal 50 to the interview management device 1 (S301). The interview management device 1 transmits the job applicant information to the recruiter terminal 50 in response to the browsing request (S302). The recruiter terminal 50 displays the screen G100 on the display unit, and receives the selection of the job applicant who takes the interview and the date and time of the interview (S303). When the job applicant and the interview date and time are selected, the interview management device 1 stores the interview date and time in the dispatch information table T200 of the job applicant (S304).

Note that, in a case where the interview management device 1 is made to give a reminder notification to the job applicant terminal 10 a predetermined time before the date and time of pickup reservation to the taxi T, when an interview with the recruiter terminal 50 is scheduled, the reminder notification may be given to the job applicant terminal 10 of the relevant job applicant in a mode different from a case where no interview is scheduled.

At the interview start time, the interview management device 1 refers to the dispatch information table T200 and transmits a video call start command to the vehicle terminal 30 and the recruiter terminal 50 associated with the job applicant ID (S305). Next, transmission and reception of a video call is started between the vehicle terminal 30 and the recruiter terminal 50 (S306, S307).

According to the above interview management system according to the embodiment of the present invention, the travel time can be utilized.

Note that, in the above interview management system according to the present embodiment, the functional configuration of each terminal or device is an example, and the functional unit described in the present example can be provided in a terminal or device different from the present example.

### REFERENCE SIGNS LIST

1 Interview management device (Conversation management device)
11 Reception unit
12 Reservation unit
13 Interview time frame calculation unit (Conversation time frame calculation unit)
14 Display control unit
15 Interview setting unit (Conversation setting unit)
16 Video call unit
17 Question processing unit
18 Communication processing unit
1A Job applicant information storage unit (First user information storage unit)
1B Dispatch information storage unit
10 Job applicant terminal
30 Vehicle terminal
40 Interviewer terminal
50 Recruiter terminal (Second user terminal)
NW Network

1. A conversation management device that is configured to be communicable with a vehicle terminal mounted in a taxi which is dispatched for transportation of a first user based on dispatch reservation information transmitted from the conversation management device and used by the first user in the taxi and a second user terminal used by a second user, and causes a conversation by video call between the vehicle terminal and the second user terminal while traveling, the conversation management device comprising:
a reception unit that receives an input regarding a pickup time, a pickup location, and a destination of the taxi for the first user;
a reservation unit that stores the dispatch reservation information of the taxi including the pickup time and the pickup location;
a conversation time frame calculation unit that calculates a drop-off time based on the pickup location and the destination, and calculates a traveling time by the taxi as a conversation-available time based on the pickup time and the drop-off time;
a first user information storage unit that records the conversation-available time in association with identification information of the first user;
a display control unit that causes the second user terminal to display the conversation-available time of the first user;
a conversation setting unit that stores date and time for a conversation between the first user and the second user, which are included in the conversation-available time; and
a video call unit that connects the vehicle terminal and the second user terminal to perform a video conversation at the date and time of the conversation.

2. The conversation management device according to claim 1, wherein
the conversation management device is configured to be further communicable with an interviewer terminal used by an interviewer,
the display control unit causes the interviewer terminal to display the conversation-available time of the first user,
the conversation setting unit stores date and time of a proxy conversation that the interviewer has a proxy conversation with the first user by a video call based on an input from the interviewer terminal, and
the video call unit causes the interviewer terminal and the vehicle terminal to connect and perform the proxy conversation, and further includes a video reproduction unit that causes the second user terminal to reproduce a moving image of the proxy conversation.

3. The conversation management device according to claim 2, wherein
the conversation management device is configured to be communicable with a plurality of second user terminals, and
the video reproduction unit causes the plurality of second user terminals to reproduce the moving image of the proxy conversation at the same time.

4. The conversation management device according to claim 2, wherein
the video call unit records the moving image of the proxy conversation, and
the video reproduction unit causes the second user terminal to reproduce the moving image of the recorded proxy conversation.

5. The conversation management device according to claim 2, further comprising
a question processing unit that receives a question to the first user input via the second user terminal and transmits the question to the interviewer terminal.

6. The conversation management device according to claim 1, wherein
the first user is a job applicant and the second user is a recruiter who considers hiring the job applicant
the first user information storage unit stores information on a resume of the first user in association with the identification information of the first user, and
the display control unit causes the second user terminal to display the information on the resume.

7. A conversation management method is a method by a computer that is configured to be communicable with a vehicle terminal mounted in a taxi which is dispatched for transportation of a first user based on dispatch reservation information transmitted from the computer and used by the first user in the taxi and a second user terminal used by a second user,
the computer enabling a conversation by a video call between the vehicle terminal and the second user terminal while traveling,
the conversation management method comprising:
a reception process of receiving an input a pickup time a pickup location, and a destination of the taxi for the first user;
a reservation process of storing the dispatch reservation information of the taxi including the pickup time and the pickup location;
a drop-off time calculation process of calculating a drop-off time based on the pickup location and the destination;
a recording process of calculating a traveling time by the taxi as a conversation-available time based on the pickup time and the drop-off time and recording the conversation-available time in association with identification information of the first user;
a display process of causing the second user terminal to display the conversation-available time of the first user;
a conversation setting process of storing date and time of a conversation between the first user and the second user, which are included in the conversation-available time; and
a video call process of connecting the vehicle terminal and the second user terminal to perform a video conversation at the date and time of the conversation.

8. A computer program for a computer that is configured to be communicable with a vehicle terminal mounted in a taxi which is dispatched for transportation of a first user based on dispatch reservation information transmitted from the computer and used by the first user in the taxi and a second user terminal used by a second user,
the computer enabling a conversation by a video call between the vehicle terminal and the second user terminal while traveling,
the computer program causes the computer to perform processes comprising:
a reception process of receiving an input regarding a pickup time, a pickup location, and a destination of the taxi for the first user;
a reservation process of storing the dispatch reservation information of the taxi including the pickup time and the pickup location;
a drop-off time calculation process of calculating a drop-off time based on the pickup location and the destination;
a recording process of calculating a traveling time by the taxi as a conversation-available time based on the pickup time and the drop-off time and recording the conversation-available time in association with identification information of the first user;
a display process of causing the second user terminal to display the conversation-available time of the first user;
a conversation setting process of storing date and time of a conversation between the first user and the second user, which are included in the conversation-available time; and
a video call process of connecting the vehicle terminal and the second user terminal to perform a video conversation at the date and time of the conversation.
